(19) United States
(12) Patent Application Publication
(10) Pub. No.: US 2026/0291799 A1
(43) Pub. Date: Sep. 24, 2026

(54) METHODS FOR TIME-FREQUENCY WAVEFORM MODULATION AND GENERATION

(71) Applicant: ZTE CORPORATION, Shenzhen, Guangdong (CN)

(72) Inventors: Yihua MA, Shenzhen (CN); Zhifeng YUAN, Shenzhen (CN); Yu XIN, Shenzhen (CN); Guanghui YU, Shenzhen (CN)

(73) Assignee: ZTE CORPORATION, Shenzhen, Guangdong (CN)

(21) Appl. No.: 19/167,809

(22) PCT Filed: Apr. 24, 2023
(86) PCT No.: PCT/CN2023/090366

§ 371 Date: Sep. 22, 2025

(51) Int. Cl. H04L 27/26

(52) U.S. Cl. CPC H04L 27/2634; H04L 27/2697

(57) ABSTRACT

A wireless communication method for use in a first wireless device. The method comprises performing a column wise dot product on each column of a first data matrix, to generate a second data matrix, performing an N point inverse Fast Fourier transform (IFFT) on each row of the second data matrix to generate a modulated data matrix, where N is a number of columns of the second data matrix, and transmitting, to a second wireless device, the modulated data matrix.

### TECHNICAL FIELD

This document is directed generally to wireless communications, and in particular to 5G communications and in more particular to 6G communications.

### BACKGROUND

OFDM (Orthogonal frequency-division multiplexing) is able to deal with frequency-selective channels, by converting time-domain convolutions of multiple paths into simple dot products. However, OFDM cannot deal with doubly-selective channels which are both time-selective and frequency-selective.

For doubly-selective channels, OTFS (Orthogonal Time Frequency & Space) may be used to support the data transmission over doubly-selective channel. However, the complexity of OTFS is significantly high, which limits the application of OTFS in practice.

### SUMMARY

This document relates to methods, systems, and devices for waveform modulation and generation, and in particular to methods, systems, and devices for time-frequency waveform modulation and generation.

The present disclosure relates to a wireless communication method for use in a first wireless device. The method comprises: performing a column wise dot product on each column of a first data matrix, to generate a second data matrix, performing an N point inverse Fast Fourier transform (IFFT) on each row of the second data matrix to generate a modulated data matrix, where N is a number of columns of the second data matrix, and transmitting, to a second wireless device, the modulated data matrix.

Various embodiments may preferably implement the following features.

Preferably, performing the column wise dot product on each column of the first data matrix comprises: calculating a dot product of i-th column of the first data matrix and an M×1 vector [e^{-j2π·0·(i-1)/MN}, e^{-j2π·1·(i-1)/MN}, . . . e^{-j2π·(M-1)·(-1)/MN}]^{T}, where i=1, 2, . . . , N, and M is a number of rows of the first data matrix.

Preferably, the first data matrix comprises at least one element carrying information data bits.

Preferably, the wireless communication method further comprises performing an M point IFFT on each column of a third data matrix to generate the first data matrix, where M is a number of rows of the third data matrix.

Preferably, the third data matrix comprises at least one element carrying information data bits.

Preferably, performing an M′-dimension discrete Fourier transform (DFT) spreading on each row of a fourth data matrix, to generate a fifth data matrix, where M′ is a number of rows of the fourth data matrix and is smaller than or equal to a number M of rows of the third data matrix, and adding (M-M′) zeros to each row of the fifth data matrix, to generate the third data matrix.

Preferably, the fourth data matrix comprises at least one element carrying information data bits.

Preferably, transmitting, to the second wireless device, the modulated data matrix comprises: converting the modulated data matrix into a vector, adding a cyclic prefix to the vector, and transmitting, to the second wireless device, the vector.

The present disclosure relates to a wireless communication method for use in a second wireless device. The method comprises: receiving, from a first wireless device, a modulated data matrix, performing a column wise dot product on each column of the modulated data matrix, to generate an eleventh data matrix, and performing an N point Fast Fourier transform (FFT) on each row of the eleventh data matrix to generate a twelfth data matrix, where N is a number of columns of the eleventh data matrix.

Various embodiments may preferably implement the following features.

Preferably, the eighth data matrix is equal to the seventh data matrix.

Preferably, the sixth data matrix comprises at least one element carrying information data bits.

Preferably, performing the column wise dot product on each column of the seventh data matrix comprises: calculating a dot product of i-th column of the seventh data matrix and an M×1 vector [e^{-j2π·0·(i-1)/MN}, e^{-j2π·1·(i-1)/MN}, e^{-j2π·(M-1)·(i-1)/MN}]^{T}, where i=1, 2, . . . , N, and M is a number of rows of the seventh data matrix.

Preferably, generating the eighth data matrix based on the seventh data matrix comprises performing an M point IFFT on each column of the seventh data matrix, to generate the eighth data matrix, wherein M is a number of rows of the seventh data matrix.

Preferably, the wireless communication method further comprises performing an M′-dimension discrete Fourier transform (DFT) spreading on each row of a ninth data matrix, to generate a tenth data matrix, where M′ is a number of rows of the ninth data matrix and is smaller than or equal to a number M of rows of the tenth data matrix, and adding (M-M′) zeros to each row of the tenth data matrix to generate the sixth data matrix, wherein the ninth data matrix comprises at least one element carrying information data bits.

Preferably, transmitting, to the second wireless device, the modulated data matrix comprises: converting the modulated data matrix into a vector, adding a cyclic prefix to the vector, and transmitting, to the second wireless device, the vector.

The present disclosure relates to a wireless communication method for use in a second wireless device. The method comprises: receiving, from a first wireless device, a modulated data matrix, performing a column wise dot product on each column of the modulated data matrix, to generate an eleventh data matrix, and performing an N point Fast Fourier transform (FFT) on each row of the eleventh data matrix to generate a twelfth data matrix, where N is a number of columns of the eleventh data matrix.

Various embodiments may preferably implement the following features.

Preferably, performing the column wise dot product on each column of the modulated data matrix comprises: calculating a dot product of each column of the modulated data matrix and an M×1 vector [e^{j2π·0·(i-1)/MN}, e^{j2π·1·(i-1)/MN}, . . . e^{j2π·(M-1)·(i-1)/MN}]^{T}, where i=1, 2, . . . , N, and M is a number of rows of the modulated data matrix.

Preferably, receiving, from the first wireless device, the modulated data matrix comprises: receiving, from the first wireless device, a vector, removing a cyclic prefix from the vector, and converting the vector into the modulated data matrix.

The present disclosure relates to a wireless communication method for use in a second wireless device. The method comprises: receiving, from a first wireless device, a modulated data matrix, performing an N point Fast Fourier transform (FFT) on each row of the modulated data matrix to generate a thirteenth data matrix, where N is a number of columns of the modulated data matrix, and performing a column wise dot product on each column of the thirteenth data matrix, to generate a fourteenth data matrix.

Various embodiments may preferably implement the following features.

Preferably, performing the column wise dot product on each column of the thirteenth data matrix, to generate the fourteenth data matrix, comprise: calculating a dot product of each column of the thirteenth data matrix and an M×1 vector [e^{j2π·0·(i-1)/MN}, e^{j2π·1·(i-1)/MN}, . . . e^{j2π·(M-1)·(i-1)/MN}]^{T}, where i=1, 2, . . . , N, and M is a number of rows of the thirteenth data matrix.

Preferably, the wireless communication method further comprises performing an M point FFT on each column of the fourteenth data matrix, to generate a fifteenth data matrix, where M is a number of rows of the fourteenth data matrix.

Preferably, the wireless communication method further comprises removing (M-M′) zeros from each row of the fifteenth data matrix, to generate a sixteenth data matrix, where M′ is a number of rows of the sixteenth data matrix and is smaller than or equal to a number M of rows of the fifteenth data matrix, and performing an M′-dimension discrete Fourier transform (DFT) de-spreading on each row of the sixteenth data matrix, to generate a seventeenth data matrix.

Preferably, receiving, from the first wireless device, the modulated data matrix comprises: receiving, from the first wireless device, a vector, removing a cyclic prefix from the vector, and converting the vector into the modulated data matrix.

The present disclosure relates to a wireless communication method for use in a second wireless device, the method comprising: receiving, from a first wireless device, a modulated data matrix, replicating the modulated data matrix into N copied data matrices, performing a column wise dot product on each column of the N copied data matrices, performing an M-point FFT on each column of the N copied data matrices after performing the column wise dot product, and performing an N-point combining on each row of i-th copied data matrix, to acquire an M×1 vector as i-th column of an eighteenth twenty-fourth data matrix, where i=1, . . . , N, wherein M is a number of rows of the copied data matrix, wherein N is a number of columns of the copied data matrix.

Various embodiments may preferably implement the following features:

Preferably, performing the column wise dot product on each column of the N copied data matrix comprises: calculating a dot product of each column of i-th copied data matrix and an M×1 vector [e^{j2π·0·(i-1)/MN}, e^{j2π·1·(i-1)/MN}, . . . e^{j2π·(M-1)·(i-1)/MN}]^{T}, where i=1, . . . , N.

Preferably, the N-point combining is implemented by one of a linear minimum mean-square error combining, a maximum-ratio combining, or a zero-forcing combining.

Preferably, the N-point combining is implemented by a discrete Fourier transform (DFT) combining.

Preferably, the wireless communication method further comprises performing a time-and-frequency domain equalization on the N copied data matrices before performing the N-point combining.

Preferably, the wireless communication method further comprises removing (M-M′) zeros from each row of the eighteenth data matrix, to generate a nineteenth data matrix, where M′ is a number of rows of the nineteenth data matrix and is smaller than or equal to M, and performing a discrete Fourier transform (DFT) de-spreading on the nineteenth data matrix, to generate a twentieth data matrix.

Preferably, receiving, from the first wireless device, the modulated data matrix comprises: receiving, from the first wireless device, a vector, removing a cyclic prefix from the vector, and converting the vector into the modulated data matrix.

The present disclosure relates to a wireless communication method for use in a first wireless device. The method comprises: transmitting, to a second wireless device, an M×N data matrix, wherein the M×N data matrix comprises a reference signal in a resource element located at an element (m0, n0) of the data matrix, where m0 is an integer between 0 and M−1 and n0 is an integer between 0 and N−1.

The data matrix further comprises K empty resource elements, wherein i-th empty resource element locates at an element (mi, ni) of the data matrix, mi is an integer between 0 and M−1 and ni is an integer between 0 and N−1, and wherein m0*N+n0 and mi*N+ni for i=1 to K are contiguous integers.

Various embodiments may preferably implement the following features.

Preferably, the reference signal is a pilot signal.

The present disclosure relates to a wireless communication method for use in a second wireless device. The method comprises: receiving, from a first wireless device, an M×N data matrix, wherein the M×N data matrix comprises a reference signal in a resource element located at an element (m0, n0) of the data matrix, where m0 is an integer between 0 and M−1 and n0 is an integer between 0 and N−1, wherein the M×N data matrix further comprises K empty resource elements, wherein i-th empty resource element locates at an element (mi, ni) of the data matrix, mi is an integer between 0 and M−1, and ni is an integer between 0 and N−1, and wherein m0*N+n0 and mi*N+ni for i=1 to K are contiguous integers.

The present disclosure relates to a first wireless device. The first wireless device comprises: a processor, configured to: perform a column wise dot product on each column of a first data matrix, to generate a second data matrix, and perform an N point inverse Fast Fourier transform (IFFT) on each row of the second data matrix to generate a modulated data matrix, where N is a number of columns of the second data matrix, and a communication unit, configured to transmit, to a second wireless device, the modulated data matrix.

Various embodiments may preferably implement the following feature:

Preferably, the processor if further configuration to perform any of the aforementioned wireless communication methods.

The present disclosure relates to a first wireless device. The first wireless communication method comprises: a processor, configured to: perform an N point inverse Fast Fourier transform (IFFT) on each row of a sixth data matrix to generate a seventh data matrix, where N is a number of columns of the sixth data matrix, generate an eighth data matrix based on the seventh data matrix, and perform a column wise dot product on each column of the eighth data matrix, to generate a modulated data matrix, a communication unit, configured to transmit, to a second wireless device, the modulated data matrix.

Various embodiments may preferably implement the following feature:

Preferably, the processor if further configuration to perform any of the aforementioned wireless communication methods.

The present disclosure relates to a second wireless device. The second wireless device comprises: a communication unit, configured to receive, from a first wireless device, a modulated data matrix, and a processor, configured to: perform a column wise dot product on each column of the modulated data matrix, to generate an eleventh data matrix, and perform an N point Fast Fourier transform (FFT) on each row of the eleventh data matrix to generate a twelfth data matrix, where N is a number of columns of the eleventh data matrix.

Various embodiments may preferably implement the following feature.

Preferably, the processor if further configuration to perform any of the aforementioned wireless communication methods.

The present disclosure relates to a second wireless device. The second wireless device comprises: a communication unit, configured to receive, from a first wireless device, a modulated data matrix, and a processor, configured to: perform an N point Fast Fourier transform (FFT) on each row of the modulated data matrix to generate a thirteenth data matrix, where N is a number of columns of the modulated data matrix, and perform a column wise dot product on each column of the thirteenth data matrix, to generate a fourteenth data matrix.

Various embodiments may preferably implement the following feature.

Preferably, the processor if further configuration to perform any of the aforementioned wireless communication methods.

The present disclosure relates to a second wireless device. The second wireless device comprises: a communication unit, configured to receive, from a first wireless device, a modulated data matrix, and a processor, configured to: replicate the modulated data matrix into N copied data matrices, perform a column wise dot product on each column of the N copied data matrices, perform an M-point FFT on each column of the N copied data matrices after performing the column wise dot product, and perform an N-point combining on each row of i-th copied data matrix, to acquire an M×1 vector as i-th column of an eighteenth twenty-fourth data matrix, where i=1, . . . , N, wherein M is a number of rows of the copied data matrix, wherein N is a number of columns of the copied data matrix.

Various embodiments may preferably implement the following feature:

Preferably, the processor if further configuration to perform any of the aforementioned wireless communication methods.

The present disclosure relates to a first wireless device. The first wireless device comprises: a communication unit, configured to transmit, to a second wireless device, an M×N data matrix, wherein the M×N data matrix comprises a reference signal in a resource element located at an element (m0, n0) of the data matrix, where m0 is an integer between 0 and M−1 and n0 is an integer between 0 and N−1, wherein the data matrix further comprises K empty resource elements, wherein i-th empty resource element locates at an element (mi, ni) of the data matrix, mi is an integer between 0 and M−1 and ni is an integer between 0 and N−1, and wherein m0*N+n0 and mi*N+ni for i=1 to K are contiguous integers.

Various embodiments may preferably implement the following feature.

Preferably, the first wireless device further comprises a processor configured to perform any of the aforementioned wireless communication methods.

The present disclosure relates to a second wireless device. The second wireless device comprises: a communication unit, configured to receive, from a first wireless device, an M×N data matrix, wherein the M×N data matrix comprises a reference signal in a resource element located at an element (m0, n0) of the data matrix, where m0 is an integer between 0 and M−1 and n0 is an integer between 0 and N−1, wherein the data matrix further comprises K empty resource elements, wherein i-th empty resource element locates at an element (mi, ni) of the data matrix, mi is an integer between 0 and M−1 and ni is an integer between 0 and N−1, and wherein m0*N+n0 and mi*N+ni for i=1 to K are contiguous integers.

Various embodiments may preferably implement the following feature:

Preferably, the second wireless device further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF DRAWINGS

FIG. 1 shows a schematic diagram of a generation of a time-frequency waveform according to an embodiment of the present disclosure.

FIG. 2 shows a schematic diagram of a generation of a time-frequency waveform according to an embodiment of the present disclosure.

FIG. 3 shows a schematic diagram of a generation of a time-frequency waveform according to an embodiment of the present disclosure.

FIG. 4 shows a schematic diagram of a generation of a time-frequency waveform according to an embodiment of the present disclosure.

FIG. 5 shows a schematic diagram of a receiver scheme of a time-frequency waveform according to an embodiment of the present disclosure.

FIG. 6 shows a schematic diagram of a receiver scheme of a time-frequency waveform according to an embodiment of the present disclosure.

FIG. 7 shows a schematic diagram of a receiver scheme of a time-frequency waveform according to an embodiment of the present disclosure.

FIG. 8 shows a schematic diagram of a receiver scheme of a time-frequency waveform according to an embodiment of the present disclosure.

FIG. 9 shows a schematic diagram of a receiver scheme of a time-frequency waveform according to an embodiment of the present disclosure.

FIG. 10 shows a schematic diagram of a receiver scheme of a time-frequency waveform according to an embodiment of the present disclosure.

FIG. 11 shows a schematic diagram of a receiver scheme of a time-frequency waveform according to an embodiment of the present disclosure.

FIG. 12 shows a schematic diagram of a receiver scheme of a time-frequency waveform according to an embodiment of the present disclosure.

FIG. 13 shows a schematic diagram of a network (architecture) according to an embodiment of the present disclosure.

FIG. 14 shows an example of a schematic diagram of a wireless terminal according to an embodiment of the present disclosure.

FIG. 15 shows an example of a schematic diagram of a wireless network node according to an embodiment of the present disclosure.

FIG. 16 shows a flowchart of a method according to an embodiment of the present disclosure.

FIG. 17 shows a flowchart of a method according to an embodiment of the present disclosure.

FIG. 18 shows a flowchart of a method according to an embodiment of the present disclosure.

FIG. 19 shows a flowchart of a method according to an embodiment of the present disclosure.

FIG. 20 shows a flowchart of a method according to an embodiment of the present disclosure.

### DETAILED DESCRIPTION

In low-mobility scenarios, the OFDM frequency-selectivity varies slowly, which is very helpful for user scheduling, and the user can be scheduled in the sub-carriers with high channel gains. In high-mobility scenarios, however, the OFDM frequency-selectivity varies very fast which makes the user scheduling extremely difficult.

In an embodiment, a waveform scheme named OTFDM (orthogonal time-frequency division multiplexing) is disclosed to deal with the doubly-selective channel and to achieve a reliable channel gain in the high-mobility scenarios.

In an embodiment, similar to the OFDM in 5G NR (new radio), the OTFDM can be implemented in two options: CP-OTFDM (cyclic prefix OTFDM) and DFT-s-OTFDM (DFT (discrete Fourier transform) spread OFDM).

In an embodiment, the OTFDM is a 2-dimension modulation waveform. For example, a 2-dimension frequency-domain data matrix X and time-domain data S are assumed. In an embodiment, X is an M×N complex matrix, which contains at least one of data signal, reference signal or zero signal for oversampling. In an embodiment, S is an M′×N complex matrix (where M′≤M), which contains at least one of data signal or reference signal. In an embodiment, X and S can be generated from MN×1 and M′N×1 data vectors, respectively.

In an embodiment, M′=240, M=256 and N=16.

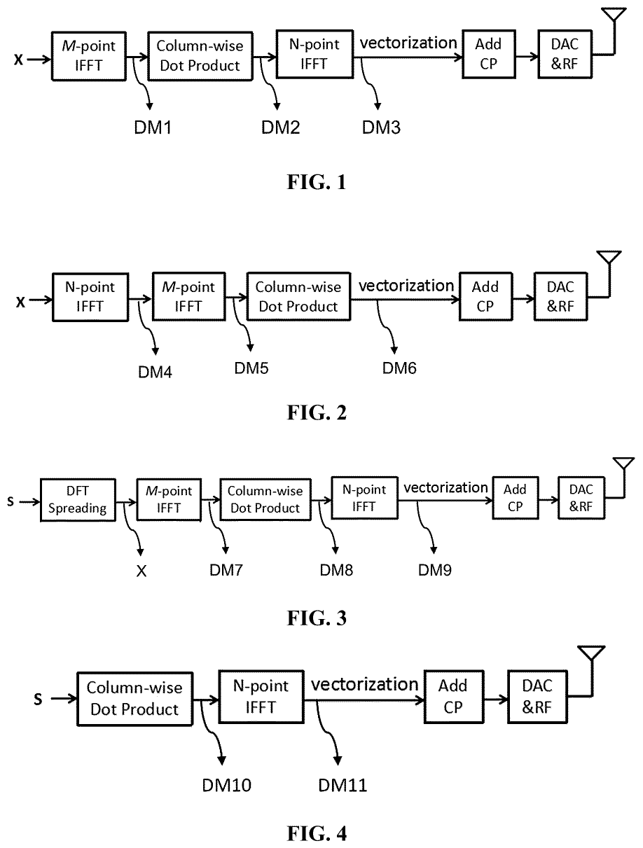

FIG. 1 shows a schematic diagram of a generation of the CP-OTFDM according to an embodiment of the present disclosure. In FIG. 1, an M-point IFFT (inverse fast Fourier transform) is performed each column of X, to generate a data matrix DM1. Next, a column wise dot product is used on the data matrix DM1, to generate a data matrix DM2, wherein the column wise dot product is performed on each column of the DM1 by:
calculating a dot product of the i-th column vector of DM1 and an M×1 vector of [e^{-j2π·0·(i-1)/MN}, e^{-j2π·1·(i-1)/MN}, . . . e^{-j2π·(M-1)·(i-1)/MN}]^{T}, where i=1, 2, . . . , N.

After the dot-product, an N-point IFFT is performed on each row vector of the data matrix DM2, to generate a data matrix DM3. The processed/modulated data matrix DM3 is then converted into a vector and a CP (cyclic prefix) is added to the vector, to generate a transmitting digital signal. The digital signal is transmitted to a DAC and RF circuit and transmitted, e.g., to a communication node.

FIG. 2 shows a schematic diagram of a generation of the CP-OTFDM according to an embodiment of the present disclosure. In comparison with FIG. 1, the order of (the M-point IFFT+the column-wise product) and the N-point IFFT can be switched since (the M-point IFFT+the column-wise product) and the N-point IFFT deal with different dimensions.

Specifically, the N-point IFFT is performed on each row vector of X, to generate a data matrix DM4. The M-point IFFT is performed on each column vector of DM4, to generate a data matrix DM5. The DM5 is then processed by the column-wise dot product, to generate a data matrix DM6. The column-wise dot product is performed by calculating the dot a dot product of the i-th column vector of DM5 and an M×1 vector of [e^{-j2π·0·(i-1)/MN}, e^{-j2π·1·(i-1)/MN}, . . . e^{-j2π·(M-1)·(i-1)/MN}]^{T}, where i=1, 2, . . . , N. Before being wirelessly transmitted, the DM6 is transformed into a vector, added the CP and processed by the DAC and RF circuitry.

FIG. 3 shows a schematic diagram of a generation of the DFT-s-OTFDM according to an embodiment of the present disclosure. In FIG. 3, a DFT spreading is performed on each column of S, to generate a data matrix DM7. In an embodiment, the X can be obtained via adding (M M′) zero row vectors to the DM7. Next, the M-point IFFT is performed on each column of X (i.e., the DM7 with (M-M′) zero row vectors in this embodiment), to generate a data matrix DM8. Then, the column wise dot product is performed on each column of the DM8, to generate a data matrix DM9. In this embodiment, the column-wise dot product is performed by calculating the dot product of the i-th column vector of the DM8 and an M×1 vector of [e^{-j2π·0·(i-1)/MN}, e^{-j2π·1·(i-1)/MN}, . . . e^{-j2π·(M-1)·(i-1)/MN}]^{T}, where i=1, 2, . . . , N.

After the dot-product, the N-point IFFT is performed on each row vector of the DM9. The processed/modulated data matrix DM9 is converted into a vector and the CP is added to the vector, to generate the transmitting digital signal. The digital signal is sent to the DAC and RF circuitry and transmitted, e.g., to another wireless communication device. Note that, the order of (M-point IFFT+column-wise dot product) and the N-point IFFT can be switched because they deal with different dimensions.

In an embodiment, the DFT spreading and M-point IFFT may be canceled, e.g., if S is not required to be oversampled or has already been oversampled. FIG. 4 shows a schematic diagram of a generation of the DFT-s-OTFDM according to an embodiment of the present disclosure. In comparison with the embodiment shown in FIG. 3, the embodiment shown in FIG. 4 removes the two modules of the DFT spreading and the M-point IFFT. Particularly, the transmitting digital signal is acquired by performing the column-wise dot product on S to generate a data matrix DM10, performing the N-point IFFT on the DM10 to generate a data matrix DM11, transforming the DM11 into a vector and adding the CP to the vector. The digital signal is sent to the DAC and RF circuitry and is transmitted to other wireless communication device(s).

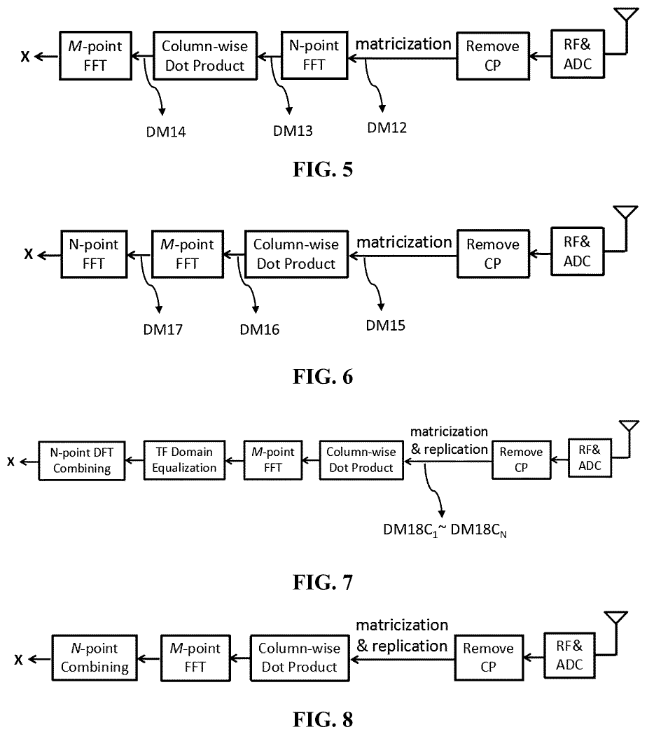

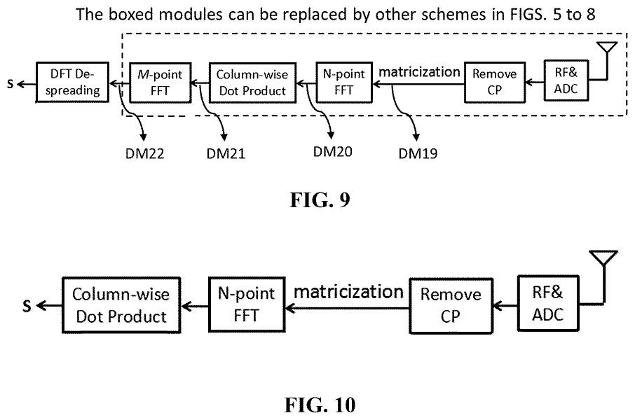

FIG. 5 shows a schematic diagram of a receiver scheme of the CP-OTFDM according to an embodiment of the present disclosure. In FIG. 5, the received signal is processed by the RF and ADC (analog-to-digital converter) circuitry and a digital signal is obtained. The digital signal is further processed to remove the CP and to be converted from a signal vector to a data matrix DM12. Then, an N point FFT (fast Fourier transform) is performed on each row vector of the DM12, to generate a data matrix DM13. Similar to the generation of the digital signal, the column wise dot product is performed on each column of the DM13, to generate a data matrix DM14. The column wise dot product in this embodiment is implemented by calculating a dot product of the i-th column vector of the DM13 and an M×1 vector of [e^{j2π·0·(i-1)/MN}, e^{j2π·1·(i-1)/MN}, . . . e^{j2π·(M-1)·(i-1)/MN}]^{T}, where i=1, 2, . . . , N.

After the dot-product, an M-point FFT is performed on each column vector of the DM14 and the transmitted data matrix X is recovered.

FIG. 6 shows a schematic diagram of a receiver scheme of the CP-OTFDM according to an embodiment of the present disclosure. In comparison with the embodiment shown in FIG. 5, the embodiment shown in FIG. 6 switches the order of the N-point FFT and (the column-wise product+the M-point FFT) because the N-point FFT and (the column-wise product+the M-point FFT) deal with different dimensions.

Specifically, in FIG. 6, the received signal is processed by the RF and ADC (analog-to-digital converter) circuitry and a digital signal is obtained. The digital signal is further processed to remove the CP and to be converted from a signal vector to a data matrix DM15. Then, the column wise dot product is performed on each column of the DM15, to generate a data matrix DM16. The column wise dot product in this embodiment is implemented by calculating a dot product of the i-th column vector of the DM15 and an M×1 vector of [e^{j2π·(M-1)·(i-1)/MN}]^{T}, where i=1, 2, . . . , N. After the dot-product, the M-point FFT is performed on each column vector of the DM16, to generate a data matrix DM17. After the N point FFT is performed on each row vector of the DM17, the transmitted data matrix X is recovered.

FIG. 7 shows a schematic diagram of a receiver scheme of the CP-OTFDM according to an embodiment of the present disclosure. In this embodiment, a time-and-frequency (TF) domain selectivity is put into considerations. In FIG. 7, the received signal is processed by the RF and the ADC circuitry, to acquire the digital signal. The digital signal is further processed to remove the CP and to be converted from a signal vector into a data matrix DM18. The DM18 is replicated into N copies DM18C₁, DM18C₂, to DM18C_{N}. Next, each column vector of the DM18Ci (i.e., i-th copy) is dot-producted by an M×1 vector of [e^{j2π·0·(i-1)/MN}, e^{j2π·1·(i-1)/MN}, . . . e^{j2π·(M-1)·(i-1)/MN}]^{T}, where i=1, 2, . . . , N.

After the dot-product, the M point FFT is performed on each column vector of each of the DM18C₁ to DM18C_{N}. Then, a TF domain equalization is performed on each of DM18C₁ to DM18C_{N}. After the TF domain equalization, an N-point DFT-based combining is performed, to combine the DM18Ci (i.e., i-th copy) into an M×1 column vector, to obtain N M×1 column vectors as an M×N matrix, which is the desired data matrix X.

FIG. 8 shows a schematic diagram of a receiver scheme of the CP-OTFDM according to an embodiment of the present disclosure. In this embodiment, the TF domain equalization and the N-point DFT combining are replaced by an N-point combining (method), such as LMMSE (linear minimum square error) combining, MRC combining or ZF combining.

FIG. 9 shows a schematic diagram of a receiver scheme of the DFT-s-OTFDM according to an embodiment of the present disclosure. In FIG. 9, the received signal is processed by the RF and the ADC circuitry, to obtain the digital signal. The digital signal is further processed to remove the CP and to be converted from a signal vector into a data matrix DM19 (e.g., an M×N matrix). Then, the N point FFT is performed on each row vector of the DM19, to generate a data matrix DM20. Similar to the transmitter schemes shown in FIGS. 1 to 4, the column wise dot product is performed on the DM20, to generate a data matrix DM 21. The column wise dot product is performed by calculating a dot product of the i-th column vector and an M×1 vector of [e^{j2π·0·(i-1)/MN}, e^{j2π·1·(i-1)/MN}, . . . e^{j2π·(M-1)·(i-1)/MN}]^{T}, where i=1, 2, . . . , N. After the dot-product, the M-point FFT is performed on each column vector of the DM21, to generate a data matrix DM22. In this embodiment, the transmitted data matrix S is recovered via performing a DFT de-spreading on the DM22.

In an embodiment, the modules except the DFT de-spreading (which are boxed in FIG. 9) can be replaced by the receiver schemes shown in any of FIGS. 5 to 8.

In an embodiment, the M-point FFT and the DFT de-spreading in FIG. 9 can be canceled as shown in FIG. 10, if S is not required to be oversampled or has already been oversampled at the transmitter side.

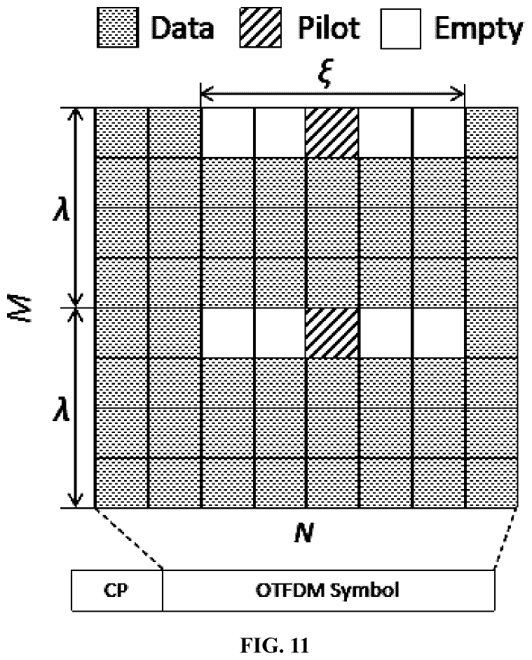

FIG. 11 shows a schematic diagram of elements of 2-dimension data matrix according to an embodiment of the present disclosure. In particular, FIG. 11 shows the resource elements (REs) in X. In this embodiment, a pilot or a reference signal is inserted with some empty guard-band REs. In FIG. 11, the empty guard-band REs are in the same row of the pilot or the reference signal.

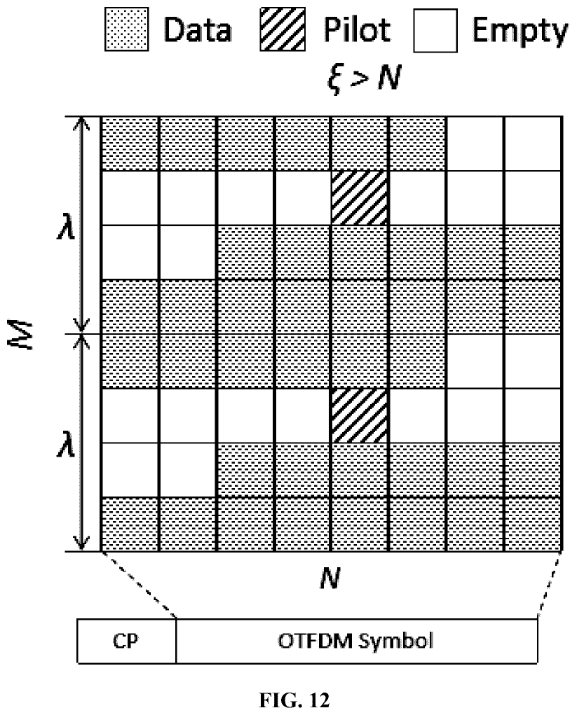

FIG. 12 shows a schematic diagram of elements of 2-dimension data matrix according to an embodiment of the present disclosure. Specifically, FIG. 12 shows the REs in X. In this embodiment, the pilot or the reference signal is inserted with some empty guard-band REs. In FIG. 12, the empty guard-band REs are in the same row of the pilot or the reference signal and further extended to adjacent rows of the pilot or the reference signal.

In an embodiment, the M×N data matrix comprises a reference signal (or a pilot signal) in a resource element located at an element (m0, n0) of the data matrix, where m0 is an integer between 0 and M−1 and n0 is an integer between 0 and N−1. In this embodiment, the data matrix further comprises K empty resource elements, wherein i-th empty resource element locates at an element (mi, ni) of the data matrix, mi is an integer between 0 and M−1 and ni is an integer between 0 and N−1. In addition, m0*N+n0 and mi*N+ni for i=1 to K are contiguous integers. In other words, the empty resource elements may be adjacent to the resource element in which the reference signal locates and in the same row of the resource element in which the reference signal locates (see, e.g., FIG. 11). Furthermore, the empty resource elements may extend to the row adjacent to the row of the resource element in which the reference signal locates (see, e.g., FIG. 12).

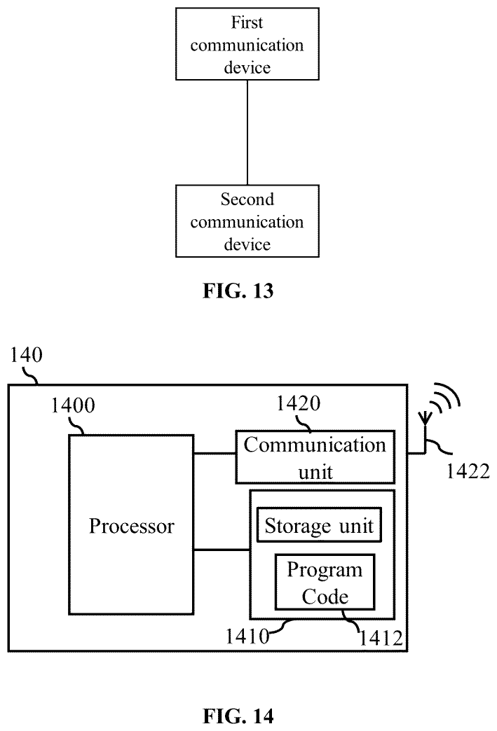

FIG. 13 shows a schematic diagram of a network (architecture) according to an embodiment of the present disclosure. The network (architecture) shown in FIG. 13 comprises a first communication device and a second communication device. In an embodiment, the second communication device may be a UE, a wireless terminal, a wireless device, a wireless node, etc. and the first communication device may be a BS, a gNB, an eNB, a repeater, a relay and so on. In an embodiment, both of the first communication device may be the UE or the BS.

FIG. 14 relates to a schematic diagram of a wireless terminal 140 according to an embodiment of the present disclosure. The wireless terminal 140 may be a user equipment (UE), a mobile phone, a laptop, a tablet computer, an electronic book or a portable computer system and is not limited herein. The wireless terminal 140 may include a processor 1400 such as a microprocessor or Application Specific Integrated Circuit (ASIC), a storage unit 1410 and a communication unit 1420. The storage unit 1410 may be any data storage device that stores a program code 1412, which is accessed and executed by the processor 1400. Embodiments of the storage unit 1410 include but are not limited to a subscriber identity module (SIM), read-only memory (ROM), flash memory, random-access memory (RAM), hard-disk, and optical data storage device. The communication unit 1420 may a transceiver and is used to transmit and receive signals (e.g., messages or packets) according to processing results of the processor 1400. In an embodiment, the communication unit 1420 transmits and receives the signals via at least one antenna 1422 shown in FIG. 14.

In an embodiment, the storage unit 1410 and the program code 1412 may be omitted and the processor 1400 may include a storage unit with stored program code.

The processor 1400 may implement any one of the steps in exemplified embodiments on the wireless terminal 140, e.g., by executing the program code 1412.

The communication unit 1420 may be a transceiver. The communication unit 1420 may as an alternative or in addition be combining a transmitting unit and a receiving unit configured to transmit and to receive, respectively, signals to and from a wireless network node (e.g., a base station).

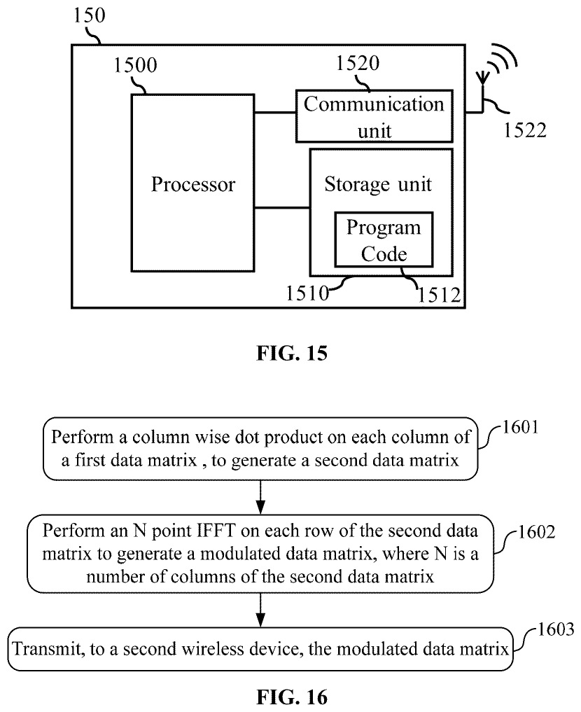

FIG. 15 relates to a schematic diagram of a wireless network node 150 according to an embodiment of the present disclosure. The wireless network node 150 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 150 may comprise (perform) at least one network function such as an access and mobility management function (AMF), a session management function (SMF), a user place function (UPF), a policy control function (PCF), an application function (AF), etc. The wireless network node 150 may include a processor 1500 such as a microprocessor or ASIC, a storage unit 1510 and a communication unit 1520. The storage unit 1510 may be any data storage device that stores a program code 1512, which is accessed and executed by the processor 1500. Examples of the storage unit 1510 include but are not limited to a SIM, ROM, flash memory, RAM, hard-disk, and optical data storage device. The communication unit 1520 may be a transceiver and is used to transmit and receive signals (e.g., messages or packets) according to processing results of the processor 1500. In an example, the communication unit 1520 transmits and receives the signals via at least one antenna 1522 shown in FIG. 15.

In an embodiment, the storage unit 1510 and the program code 1512 may be omitted. The processor 1500 may include a storage unit with stored program code.

The processor 1500 may implement any steps described in exemplified embodiments on the wireless network node 150, e.g., via executing the program code 1512.

The communication unit 1520 may be a transceiver. The communication unit 1520 may as an alternative or in addition be combining a transmitting unit and a receiving unit configured to transmit and to receive, respectively, signals to and from a wireless terminal (e.g., a user equipment or another wireless network node).

FIG. 16 shows a flowchart of a method according to an embodiment of the present disclosure. The method shown in FIG. 16 may be used in a first wireless device (e.g., the first communication device shown in FIG. 13) and comprises the following steps:
Step 1601: Perform a column wise dot product on each column of a first data matrix, to generate a second data matrix.
Step 1602: Perform an N point IFFT on each row of the second data matrix to generate a modulated data matrix, where N is a number of columns of the second data matrix.
Step 1603: Transmit, to a second wireless device, the modulated data matrix.

In FIG. 16, the first wireless device generates the modulated data matrix by:
performing a column wise dot product on each column of a first data matrix (e.g., S shown in FIG. 4), to generate a second data matrix (e.g., DM10 shown in FIG. 4), and
performing an N point IFFT on each row of the second data matrix to generate a modulated data matrix (e.g., DM11 shown in FIG. 4), where N is a number of columns of the second data matrix.

In an embodiment, the column wise dot produce is performed by:
calculating a dot product of i-th column of the first data matrix and an M×1 vector [e^{-j2π·0·(i-1)/MN}, e^{-j2π·1·(i-1)/MN}, . . . e^{-j2π·(M-1)·(i-1)/MN}]^{T},

where i=1, 2, . . . , N, and M is the number of rows of the first data matrix.

In an embodiment, the first data matrix comprises at least one element carrying information data bits. For example, the first data matrix may be S shown in FIG. 4, i.e., M′×N complex matrix (where M′≤M) which contains at least one of data signal or reference signal.

In an embodiment, the first wireless device may further perform an M point IFFT on each column of a third data matrix (e.g., X in FIG. 1) to generate the first data matrix (e.g., DM1 in FIG. 1), where M is the number of rows of the third data matrix.

In an embodiment, the third data matrix comprises at least one element carrying information data bits, e.g., X which is the 2-dimension frequency-domain data matrix or an M×N complex matrix containing at least one of data signal, reference signal or zero signal for oversampling.

In an embodiment, the first wireless device further performs an M′-dimension DFT spreading on each row of a fourth data matrix (e.g., S in FIG. 3), to generate a fifth data matrix, where M′ is a number of rows of the fourth data matrix and is smaller than or equal to a number M of rows of the third data matrix and adds (M-M′) zeros to each row of the fifth data matrix, to generate the third data matrix (e.g., X in FIG. 3).

In an embodiment, the fourth data matrix comprises at least one element carrying information data bits, e.g., M′×N complex matrix containing at least one of data signal or reference signal.

In an embodiment, the first wireless device transmits the modulated data matrix to the second wireless device by converting the modulated data matrix into a vector, adding a CP to the vector, and transmitting, to the second wireless device, the vector.

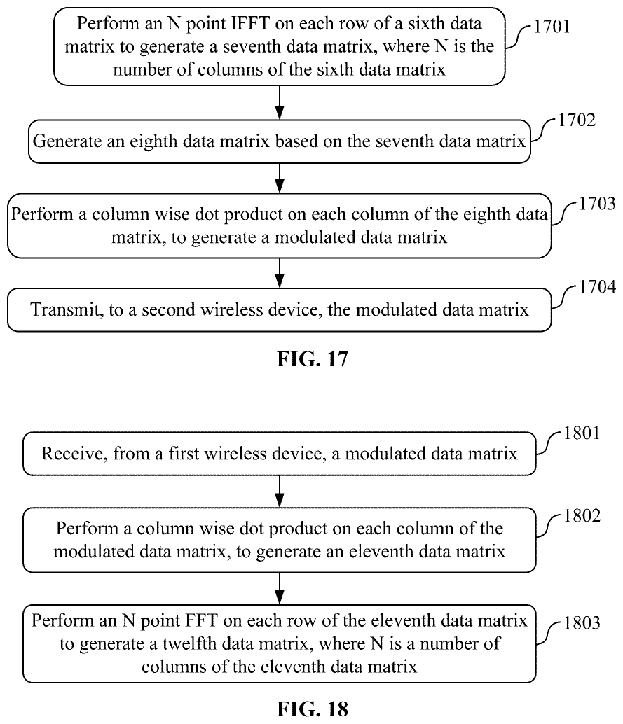

FIG. 17 shows a flowchart of a method according to an embodiment of the present disclosure. The method shown in FIG. 17 may be used in a first wireless device (e.g., the first communication device shown in FIG. 13) and comprises the following steps:
Step 1701: Perform an N point IFFT on each row of a sixth data matrix to generate a seventh data matrix, where N is the number of columns of the sixth data matrix.
Step 1702: Generate an eighth data matrix based on the seventh data matrix.
Step 1703: Perform a column wise dot product on each column of the eighth data matrix, to generate a modulated data matrix.
Step 1704: Transmit, to a second wireless device, the modulated data matrix.

In FIG. 17, the first wireless device performs an N point IFFT on each row of a sixth data matrix to generate a seventh data matrix, where N is a number of columns of the sixth data matrix. Next, the first wireless device generates an eighth data matrix based on the seventh data matrix and performs a column wise dot product on each column of the eighth data matrix, to generate a modulated data matrix. The modulated data matrix is transmitted to a second wireless device (e.g., the second communication device shown in FIG. 13).

In an embodiment, the first wireless device generates the eighth data matrix based on the seventh data matrix means that first wireless device generates the eighth data matrix by using the seventh data matrix or that the first wireless device uses the seventh data matrix to generate the eighth data matrix.

In an embodiment, the eighth data matrix is equal to the seventh data matrix. In this embodiment, the step 1702 may be omitted.

In an embodiment, the sixth data matrix comprises at least one element carrying information data bits. For example, the sixth data matrix may be X which is an the 2-dimension frequency-domain data matrix or an M×N complex matrix containing at least one of data signal, reference signal or zero signal for oversampling.

In an embodiment, the column-wise dot product is performed by:
calculating a dot product of i-th column of the seventh data matrix and an M×1 vector [e^{-j2π·0·(i-1)/MN}, e^{-j2π·1·(i-1)/MN}, . . . e^{-j2π·(M-1)·(-1)/MN}]^{T}, where i=1, 2, . . . , N, and M is the number of rows of the seventh data matrix.

In an embodiment, the first wireless device performs an M point IFFT on each column of the seventh data matrix, to generate the eighth data matrix. In this embodiment, M is the number of rows of the seventh data matrix.

In an embodiment, the first wireless device performs an M′-dimension DFT spreading on each row of a ninth data matrix, to generate a tenth data matrix and adds (M-M′) zeros to each row of the tenth data matrix to generate the sixth data matrix. In this embodiment, M′ is the number of rows of the ninth data matrix and is smaller than or equal to the number M of rows of the tenth data matrix.

In an embodiment, the ninth data matrix comprises at least one element carrying information data bits, e.g., M′×N complex matrix containing at least one of data signal or reference signal.

In an embodiment, the first wireless device transmits the modulated data matrix to the second wireless device by converting the modulated data matrix into a vector, adding a CP to the vector, and transmitting, to the second wireless device, the vector.

FIG. 18 shows a flowchart of a method according to an embodiment of the present disclosure. The method shown in FIG. 18 may be used in a second wireless device (e.g., the second communication device shown in FIG. 13) and comprises the following steps:
Step 1801: Receive, from a first wireless device, a modulated data matrix.
Step 1802: Perform a column wise dot product on each column of the modulated data matrix, to generate an eleventh data matrix.
Step 1803: Perform an N point FFT on each row of the eleventh data matrix to generate a twelfth data matrix, where N is a number of columns of the eleventh data matrix.

In FIG. 18, the second wireless device receives a modulated data matrix from a first wireless device (e.g., first communication device shown in FIG. 13). To demodulate/recover the modulated data matrix, the second wireless device may perform a column wise dot product on each column of the modulated data matrix to generate an eleventh data matrix and perform an N point FFT on each row of the eleventh data matrix to generate a twelfth data matrix, where N is a number of columns of the eleventh data matrix.

In an embodiment, the twelfth data matrix is the demodulated/recovered data matrix.

In an embodiment, the second wireless device performs the column wise dot product on each column of the modulated data matrix by:
calculating a dot product of each column of the modulated data matrix and an M×1 vector [e^{j2π·0·(i-1)/MN}, e^{j2π·1·(i-1)/MN}, . . . e^{j2π·(M-1)·(i-1)/MN}]^{T}, where i=1, 2, . . . , N, and M is the number of rows of the modulated data matrix.

In an embodiment, the second wireless device may further perform an M-point FFT on the eleventh data matrix before the N point FFT (see, e.g., FIG. 6).

In an embodiment, the second wireless device may further remove (M-M′) zeros from each row of the twelfth data matrix and then perform an M′-dimension DFT de-spreading on each row of the processed twelfth data matrix, to generate a demodulated data matrix. In this embodiment, M′ is the number of rows of the processed eleventh data matrix (i.e., the twelfth data matrix after being removed (M-M′) zeros) and is smaller than or equal to the number M of rows of the twelfth data matrix. This embodiment may be referred to FIG. 6 and FIG. 9.

In an embodiment, the second wireless device receives the modulated data matrix from the first wireless device by: receiving, from the first wireless device, a vector, removing a cyclic prefix from the vector, and converting the vector into the modulated data matrix.

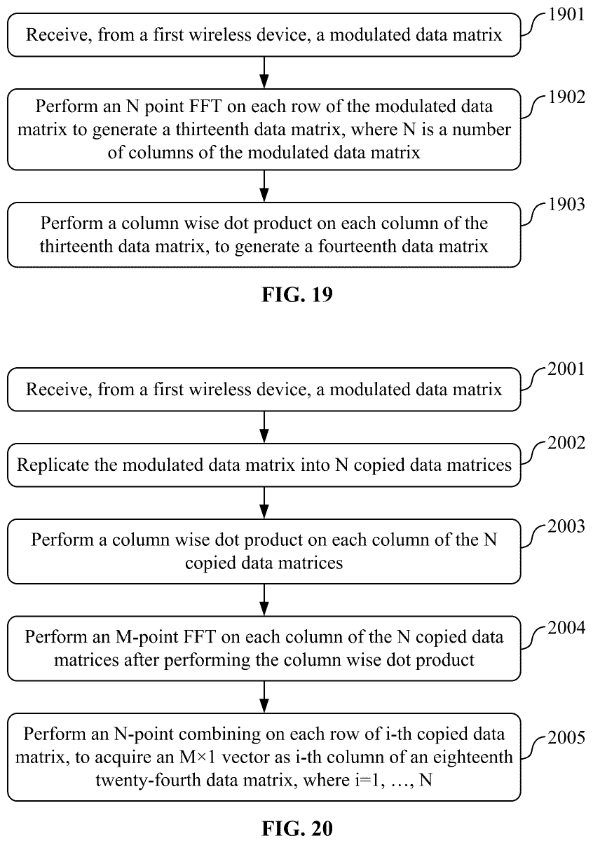

FIG. 19 shows a flowchart of a method according to an embodiment of the present disclosure. The method shown in FIG. 19 may be used in a second wireless device (e.g., the second communication device shown in FIG. 13) and comprises the following steps:
Step 1901: Receive, from a first wireless device, a modulated data matrix.
Step 1902: Perform an N point FFT on each row of the modulated data matrix to generate a thirteenth data matrix, where N is a number of columns of the modulated data matrix.
Step 1903: Perform a column wise dot product on each column of the thirteenth data matrix, to generate a fourteenth data matrix.

In FIG. 19, the second wireless receives a modulated data matrix from a first wireless device. To demodulate/recover the modulated data matrix, the second wireless device may perform an N point FFT on each row of the modulated data matrix to generate a thirteenth data matrix and perform a column wise dot product on each column of the thirteenth data matrix, to generate a fourteenth data matrix. In this embodiment, N is a number of columns of the modulated data matrix.

In an embodiment, the fourteenth data matrix is the demodulated/recovered data matrix (see, e.g., FIG. 10).

In an embodiment, the second wireless device performs the column wise dot product on each column of the thirteenth data matrix by:
calculating a dot product of each column of the thirteenth data matrix and an M×1 vector [e^{j2π·0·(i-1)/MN}, e^{j2π·1·(i-1)/MN}, . . . e^{j2π·(M-1)·(i-1)/MN}]^{T},
where i=1, 2, . . . , N, and M is the number of rows of the thirteenth data matrix.

In an embodiment, the second wireless device may further perform an M point FFT on each column of the fourteenth data matrix, to generate a fifteenth data matrix, where M is a number of rows of the fourteenth data matrix.

In an embodiment, the fifteenth data matrix is the recovered/demodulated data matrix (e.g., X).

In an embodiment, the second wireless device may further remove (M-M′) zeros from each row of the fifteenth data matrix to generate a sixteenth data matrix and perform an M′-dimension DFT de-spreading on each row of the sixteenth data matrix, to generate a seventeenth data matrix. In this embodiment, M′ is a number of rows of the sixteenth data matrix and is smaller than or equal to a number M of rows of the fifteenth data matrix. The seventeenth data matrix may be the demodulated/recovered data matrix (see, e.g., FIG. 9).

In an embodiment, the second wireless device receives the modulated data matrix from the first wireless device by: receiving, from the first wireless device, a vector, removing a cyclic prefix from the vector, and converting the vector into the modulated data matrix.

FIG. 20 shows a flowchart of a method according to an embodiment of the present disclosure. The method shown in FIG. 20 may be used in a second wireless device (e.g., the second communication device shown in FIG. 13) and comprises the following steps:
Step 2001: Receive, from a first wireless device, a modulated data matrix.
Step 2002: Replicate the modulated data matrix into N copied data matrices.
Step 2003: Perform a column wise dot product on each column of the N copied data matrices.
Step 2004: Perform an M-point FFT on each column of the N copied data matrices after performing the column wise dot product.
Step 2005: Perform an N-point combining on each row of i-th copied data matrix, to acquire an M×1 vector as i-th column of an eighteenth twenty-fourth data matrix, where i=1, . . . , N.

In FIG. 20, the second wireless device receives a modulated data matrix from a first wireless device. In this embodiment, the second wireless device replicates the modulated data matrix into N copied data matrices and performs a column wise dot product on each column of the N copied data matrices. After performing the column wise dot product, the second wireless device performs an M-point FFT on each column of the N copied data matrices and perform an N-point combining on each row of i-th copied data matrix, to acquire an M×1 vector as i-th column of an eighteenth twenty-fourth data matrix, where i=1, . . . , N. Note that M is the number of rows of the copied data matrix and N is the number of columns of the copied data matrix.

In an embodiment, the second wireless device performs the column wise dot product on each column of the N copied data matrix by:
calculating a dot product of each column of i-th copied data matrix and an M×1 vector [e^{j2π·0·(i-1)/MN}, e^{j2π·1·(i-1)/MN}, . . . e^{j2π·(M-1)·(i-1)/MN}]^{T}, where i=1, . . . , N.

In an embodiment, the N-point combining is implemented by one of a linear minimum mean-square error combining, a maximum-ratio combining, or a zero-forcing combining (see, e.g., FIG. 8).

In an embodiment, the N-point combining is implemented by a DFT combining. In this embodiment, the second wireless device may further perform a time-and-frequency domain equalization on the N copied data matrices before performing the N-point combining (see, e.g., FIG. 7).

In an embodiment, the second wireless device may further remove (M-M′) zeros from each row of the eighteenth data matrix, to generate a nineteenth data matrix and perform a DFT de-spreading on the nineteenth data matrix, to generate a twentieth data matrix (see, e.g., FIGS. 7 to 9). In this embodiment, M′ is a number of rows of the nineteenth data matrix and is smaller than or equal to M.

In an embodiment, the second wireless device receives the modulated data matrix from the first wireless device by: receiving, from the first wireless device, a vector, removing a cyclic prefix from the vector, and converting the vector into the modulated data matrix.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a first wireless device, the method comprising:
performing a column wise dot product on each column of a first data matrix, to generate a second data matrix,
performing an N point inverse Fast Fourier transform (IFFT) on each row of the second data matrix to generate a modulated data matrix, where N is a number of columns of the second data matrix, and
transmitting, to a second wireless device, the modulated data matrix.

2. The wireless communication method of claim 1, wherein performing the column wise dot product on each column of the first data matrix comprises:
calculating a dot product of i-th column of the first data matrix and an M×1 vector [e^{-j2π·0·(i-1)/MN}, e^{-j2π·1·(i-1)/MN}, . . . e^{-j2π·(M-1)·(i-1)/MN}]^{T}, where i=1, 2, . . . , N, and M is a number of rows of the first data matrix.

3. The wireless communication method of claim 1, wherein the first data matrix comprises at least one element carrying information data bits.

4. The wireless communication method of claim 1, further comprises:
performing an M point IFFT on each column of a third data matrix to generate the first data matrix, where M is a number of rows of the third data matrix.

5. The wireless communication method of claim 4, wherein the third data matrix comprises at least one element carrying information data bits.

6. The wireless communication method of claim 1, further comprising:
performing an M′-dimension discrete Fourier transform (DFT) spreading on each row of a fourth data matrix, to generate a fifth data matrix, where M′ is a number of rows of the fourth data matrix and is smaller than or equal to a number M of rows of the third data matrix, and
adding (M-M′) zeros to each row of the fifth data matrix, to generate the third data matrix,
wherein the fourth data matrix comprises at least one element carrying information data bits.

7. A wireless communication method for use in a first wireless device, the method comprising:
performing an N point inverse Fast Fourier transform (IFFT) on each row of a sixth data matrix to generate a seventh data matrix, where N is a number of columns of the sixth data matrix,
generating an eighth data matrix based on the seventh data matrix,
performing a column wise dot product on each column of the eighth data matrix, to generate a modulated data matrix, and
transmitting, to a second wireless device, the modulated data matrix.

8. The wireless communication method of claim 7, wherein the eighth data matrix is equal to the seventh data matrix.

9. The wireless communication method of claim 7, wherein the sixth data matrix comprises at least one element carrying information data bits.

10. The wireless communication method of claim 7, wherein performing the column wise dot product on each column of the seventh data matrix comprises:
calculating a dot product of i-th column of the seventh data matrix and an M×1 vector [e^{-j2π·0·(i-1)/MN}, e^{-j2π·1·(i-1)/MN}, . . . e^{-j2π·(M-1)·(i-1)/MN}]^{T}, where i=1, 2, . . . , N, and M is a number of rows of the seventh data matrix.

11. The wireless communication method of claim 7, wherein generating the eighth data matrix based on the seventh data matrix comprises:
performing an M point IFFT on each column of the seventh data matrix, to generate the eighth data matrix, wherein M is a number of rows of the seventh data matrix.

12. The wireless communication method of claim 7, further comprising:
performing an M′-dimension discrete Fourier transform (DFT) spreading on each row of a ninth data matrix, to generate a tenth data matrix, where M′ is a number of rows of the ninth data matrix and is smaller than or equal to a number M of rows of the tenth data matrix, and
adding (M-M′) zeros to each row of the tenth data matrix to generate the sixth data matrix,
wherein the ninth data matrix comprises at least one element carrying information data bits.

13. The wireless communication method of claim 1, wherein transmitting, to the second wireless device, the modulated data matrix comprises:
converting the modulated data matrix into a vector,
adding a cyclic prefix to the vector, and
transmitting, to the second wireless device, the vector.

14. A wireless communication method for use in a second wireless device, the method comprising:
receiving, from a first wireless device, a modulated data matrix,
performing a column wise dot product on each column of the modulated data matrix, to generate an eleventh data matrix, and
performing an N point Fast Fourier transform (FFT) on each row of the eleventh data matrix to generate a twelfth data matrix, where N is a number of columns of the eleventh data matrix.

15. The wireless communication method of claim 14, wherein performing the column wise dot product on each column of the modulated data matrix comprises:
calculating a dot product of each column of the modulated data matrix and an M×1 vector [e^{j2π·0·(i-1)/MN}, e^{j2π·1·(i-1)/MN}, . . . e^{j2π·(M-1)·(i-1)/MN}]^{T}, where i=1, 2, . . . , N, and M is a number of rows of the modulated data matrix.

16-24. (canceled)

25. The wireless communication method of claim 14, wherein receiving, from the first wireless device, the modulated data matrix comprises:
receiving, from the first wireless device, a vector,
removing a cyclic prefix from the vector, and
converting the vector into the modulated data matrix.

26-29. (canceled)

30. A first wireless device, comprising:
a memory and at least one processor, wherein
the memory is configured to store at least one program; and
when executed by the at least one processor, the at least one program causes the at least one processor to perform the at least one processor to perform the wireless communication method of claim 1.

31. (canceled)

32. A first wireless device, comprising:
a memory and at least one processor, wherein
the memory is configured to store at least one program; and
when executed by the at least one processor, the at least one program causes the at least one processor to perform the at least one processor to perform the wireless communication method of claim 7.

33. (canceled)

34. A second wireless device, comprising:
a memory and at least one processor, wherein
the memory is configured to store at least one program; and
when executed by the at least one processor, the at least one program causes the at least one processor to perform the at least one processor to perform the wireless communication method of claim 14.

35-44. (canceled)

45. The wireless communication method of claim 7, wherein transmitting, to the second wireless device, the modulated data matrix comprises:
converting the modulated data matrix into a vector,
adding a cyclic prefix to the vector, and
transmitting, to the second wireless device, the vector.
